(19) United States
(12) Patent Application Publication
(10) Pub. No.: US 2006/0271426 A1
(43) Pub. Date: Nov. 30, 2006

(54) Posted price market for online search and content advertisements

(75) Inventors: Christian H. Borgs, Seattle, WA (US); Jennifer T. Chayes, Seattle, WA (US); Uriel M. Feige, Bellevue, WA (US); Mohammad Mahdian, Bellevue, WA (US); Amin Saberi, Palo Alto, CA (US); Joshua T. Goodman, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/141,307

(22) Filed: May 31, 2005

(51) Int. Cl. G06Q 30/00; G06F 17/00

(52) U.S. Cl. 705/14; 705/400

(57) ABSTRACT

A computer-implemented system that facilitates sale of advertising space on a plurality of web pages by way of a posted-price market comprises an interface component that receives pricing information relating to a plurality of spaces on the plurality of search pages. A posting component communicatively coupled to the interface component posts the pricing information so that the pricing information is accessible to a prospective buyer. For example, the pricing information can be based at least in part on one or more of size of a space on a search page, location of a space on a search page, duration that a space will be utilized for advertising, and demand associated with a space on a search page. In accordance with another aspect of the subject invention, the pricing information can relate to a percentage of page views that will display advertisements relating to a purchaser on at least one of the plurality of spaces.

### BACKGROUND OF THE INVENTION

Advancements in networking and computing technologies has enabled transformation of computers from low performance/high cost devices capable of performing basic word processing and computing basic mathematical computations to high performance/low cost machines capable of a myriad of disparate functions. For example, a consumer level computing device can be employed to aid a user in paying bills, tracking expenses, communicating nearly instantaneously with friends or family across large distances by way of email, obtaining information from networked data repositories, and numerous other functions/activities. Computers and peripherals associated therewith have thus become a staple in modem society, utilized for both personal and business activities.

The Internet in particular has provided users with a mechanism for obtaining information regarding any suitable subject matter. For example, various web sites are dedicated to posting text, images, and video relating to world, national, and/or local news. A user with knowledge of a Uniform Resource Locator (URL) associated with one of such web sites can simply enter the URL into a web browser to be provided with the web site and access content thereon. Another conventional manner of locating desired information from the Internet is through utilization of a search engine. For instance, a user can enter a word or series of words into a search field and thereafter initiate the search engine (e.g., through depression of a button, one or more keystrokes, voice commands, . . . ). The search engine then utilizes search algorithms to locate web sites related to the word or series of words entered by the user into the search field, and the user can then select one of the web sites returned by the search engine to review content therein.

As more and more people have begun to utilize the Internet, it has become apparent that revenue opportunities exist for small and large businesses alike. For instance, many retail companies utilize the Internet to sell goods online, thereby reducing costs associated with managing and maintaining a store location, providing an ability to centralize inventory, and various other similar benefits that result in decreased costs that are passed on to customers. Given this increased use of the Internet for generating business and/or revenue, it has also become apparent that the Internet can be utilized as an advertising mechanism. In one example, an individual who enters the term “flower” into a search engine may be interested in purchasing flowers—thus, it is beneficial for a company that sells flowers to advertise to that user at the point in time that the user is searching for the aforementioned term. Oftentimes users will see the advertisements and click on such advertisements to purchase flowers, thereby creating business for the flower retailer. Furthermore, the search engine is provided with additional revenue by selling advertisement space for a particular period of time to the flower retailer when the term “flower” is utilized as a search term. In a similar example, a sporting goods company may wish to display advertisements on a web site related to sports, and can purchase advertising space for a limited amount of time on the web site. Again, the buying and selling of advertising space can lead to increased revenue for an owner of the web site as well as the advertiser.

Conventionally, space on a web site or search engine is bought or sold in an auction manner. Continuing with the above “flower” example, there may exist a plurality of companies who are interested in purchasing a particular space for specified times within a defined time range for advertising purposes. These companies can enter bids for such space, and upon entry of the search term the highest bid is accepted and an advertisement associated with the company who entered such bid is displayed. The bids can be standing bids that expire after a certain amount of time, after a particular number of clicks on the advertisement, after a specified number of times that the bid is the highest bid, and the like. Furthermore, the bids can be dynamically adjusted, so that the bid is incrementally increased until such bid is the highest bid. Various factors can be taken into account by a company who enters a bid, including location of a portion of a web site that will be utilized for advertising, size of the portion, length of time that the advertisement will be displayed, and the like. Web sites can auction space of pages in a similar manner. For instance, each time a page is downloaded, an auction for portions of such page can be undertaken.

Auctioning of items (e.g., advertising space associated with a web page), however, is associated with various inherent deficiencies. For instance, auctions can be associated with customer dissatisfaction, as the process does not provide a customer with absolute control over a purchase. In more detail, since it is technically difficult to implement a multi-unit auction with bidder constraints on unequal goods the customer typically will not have precise knowledge of a bundle of items to be received, which often causes a customer to be conservative during bidding.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates generally to sale of impressions (e.g., on-line advertising space) by way of a posted price market. As the impressions can be sold through utilization of a market, one or more aspects of the subject invention relates to creating a futures, options, and or derivatives market for sale of impressions. Any other suitable conventional financial instruments can also be utilized in connection with the subject invention. To facilitate sale of impressions by way of a posted price market, a robust and accurate pricing mechanisms can be employed. For example, a price generation component can analyze historical data relating to sales of advertising space and determine demand associated with the advertising space. In particular, a robust inventory system can be created and managed that can be analyzed to determine available inventory, prior sales, prior purchasers, and the like. For instance, if advertising space is sold with respect to a percentage, it would be undesirable for a sum of sold percentages to exceed 100. In still more detail, a purchaser can desire that an advertisement associated therewith be displayed X percent of times that a particular search term is entered into a search engine. Moreover, an inventory system can be utilized to track and analyze sales records associated with particular advertising spaces—thus, through analysis of the inventory system, a price to assign to advertising spaces and/or clusters thereof can be generated.

A common problem with search advertising is “click fraud.” Advertisers may seek to defraud a competitor by clicking on their ad. This may exhaust the competitor's budget or lower his return on investment. Another problem is “impression fraud.” In some systems, rather than selling clicks, a search engine or other provider sells impressions, charging advertisers for each impression shown. An advertiser might try to generate impressions on a competitor, such as by searching for terms used by the competitor, without generating clicks, exhausting the competitor's budget, or lowering his return on investment. In accordance with another aspect of the subject invention, the advertising space can be sold as a percentage of page views that will include purchased advertising space. In a specific example, an advertiser can purchase impressions on ten percent of all search pages that are generated through utilization of a particular search term. Selling impressions in such a manner can mitigate occurrence of both click fraud and impression fraud taken upon a purchaser of the impressions as well as a seller of such impressions, particularly if the impressions (while keeping with the purchased percentages) are displayed at random. More particularly, a pattern should not exist, as an individual intending to defraud an advertiser or impression provider can utilize fake searches if a pattern of display can be discerned. If the advertisements are displayed truly at random, (e.g. as a percentage of total impressions), then an advertiser cannot defraud a competitor, since no matter how many fraudulent impressions or clicks are generated, the percentage of total impressions remains the same, and there is no charge per click.

To render this aspect of the subject invention more robust, percentage information can vary depending upon where in a search a purchased term appears. For instance, a purchased term that appears as an entirety of a search string can be associated with a first percentage, the purchased term can be associated with a second percentage dependent upon location of the term within a search string if such term is not the entirety of the search string, etc. Any suitable manner of pricing search terms and allocating percentages associated with such terms is contemplated and intended to fall under the scope of the hereto-appended claims. Furthermore, this manner of selling impressions based upon percentages of page views that will display the impressions can be utilized for content pages as well as search pages. Moreover, while sale of impressions is described in context of a posted price market, it can be discerned that sale of a percentage of page views that will display an impression or impressions can be undertaken by auction.

In traditional “broad match” searches, any search phrase matching a keyword is sold and a percentage of all such matches can be sold. However, if x percent of broad matches for any word A is sold, no more than 100—x percent can be sold for any word B, because all searches might be of the form AB. Thus, a disparate type of sale can be utilized, such as a prefix match. For instance, up to 100% of matches of phrases starting with A can be sold, and up to 100% of matches of phrases starting with B can be sold. This notion can be extended to multiple word prefixes, (e.g. selling up to 100% of matches of phrases starting with “CD”). Similarly, suffix matches can be sold.

When selling percentages of impressions of search terms, it can be helpful to advertisers if the price is stable over time. However, a given keyword A may have a larger number of impressions on Sunday than on Monday. This can lead to price instability, making life more complex for advertisers. Accordingly, percentages of impressions of search terms can be sold over a period of time greater than a day, such as a week, a month, etc.

Further, while described with respect to selling percentages of impressions with respect search terms, URLs, and the like, it can be discerned that at least some concepts described herein can be applied to selling other suitable fixed commodities. For instance, a percentage of all impressions on a particular website can be sold by way of one or more aspects of the subject invention. Further, a market mechanism can be employed to buy and sell portions of the traffic of a particular website. Similarly, an advertising supported program, such as email or instant messaging, can sell a percentage of all ads displayed in the program, or a percentage of ads shown for messages containing a certain word by way of one or more aspects of the subject invention.

In accordance with yet another aspect of the subject invention, the percentages can be converted to any suitable payment plan at time of implementation of the impression. For instance, advertisers may be wary of purchasing an uncertain item (e.g., if searches for a purchased term drop, then the advertiser may get less than what was expected). Conventionally, advertisers pay based at least in part upon clicks, secure clicks, acquisitions, and/or click through rate. To facilitate conversion from a percentage-based purchase to a purchase based at least in part upon disparate (conventional) parameters, a conversion table can be created and utilized. For example, historical data that can be analyzed to estimate a number of clicks that can be expected for a particular term with respect to a certain advertiser. Given this estimate, the percentage-based purchase can easily be converted to a payment plan based at least in part upon clicks. Estimates of expected secure clicks, click through rates, and/or acquisitions can also be included within the conversion table. Thus, the seller of advertising space will receive similar revenue relating to a click-based sale as compared to a percentage-based sale.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a high-level block diagram of a system that facilitates selling impressions or advertising space by way of a posted price market in accordance with an aspect of the subject invention.

FIG. 2 is a block diagram of a system that facilitates determining price information associated with impressions that are sold by way of a posted price market in accordance with an aspect of the subject invention.

FIG. 3 is a block diagram of a system that facilitates estimating demand in connection with determining price information associated with impressions that are sold by way of a posted price market in accordance with an aspect of the subject invention.

FIG. 4 is a block diagram of a system that facilitates conversion of sale parameters in accordance with an aspect of the subject invention.

FIG. 5 is a block diagram of a system that facilitates analyzing inventory in connection with selling impressions by way of a posted price market in accordance with an aspect of the subject invention.

FIG. 6 is a block diagram of a system that facilitates analyzing proxies to estimate demand associated with impressions, the demand utilized to generate pricing information for impressions sold by way of a posted price market in accordance with an aspect of the subject invention.

FIG. 7 is a representative flow diagram illustrating a methodology for selling impressions by way of a posted price market in accordance with an aspect of the subject invention.

FIG. 8 is a representative flow diagram illustrating a methodology for determining demand associated with impressions in accordance with an aspect of the subject invention.

FIG. 9 is a representative flow diagram illustrating a methodology for converting a purchase from a percentage-based purchase to a purchase based on disparate parameters in accordance with an aspect of the subject invention.

FIG. 10 is a representative flow diagram illustrating a methodology for providing a futures, options, and/or derivatives market for impressions in accordance with an aspect of the subject invention.

FIG. 11 is a representative flow diagram illustrating a methodology for modifying prices of impression based upon analysis of proxies in accordance with an aspect of the subject invention.

FIG. 12 is a representative flow diagram illustrating a methodology for clustering search terms for pricing purposes in accordance with an aspect of the subject invention.

FIG. 13 is a block diagram of a system that facilitates artificially altering supply of impressions in accordance with an aspect of the subject invention.

FIG. 14 is a schematic block diagram illustrating a suitable operating environment in accordance with an aspect of the subject invention.

FIG. 15 is a schematic block diagram of a sample-computing environment with which the subject invention can interact.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers. The word “exemplary” is used herein to mean serving as an example, instance, or illustration. Any aspect or design described herein as “exemplary” is not necessarily to be construed as preferred or advantageous over other aspects or designs.

Furthermore, the present invention may be implemented as a method, apparatus, or article of manufacture using standard programming and/or engineering techniques to produce software, firmware, hardware, or any combination thereof to control a computer to implement the disclosed invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the subject invention.

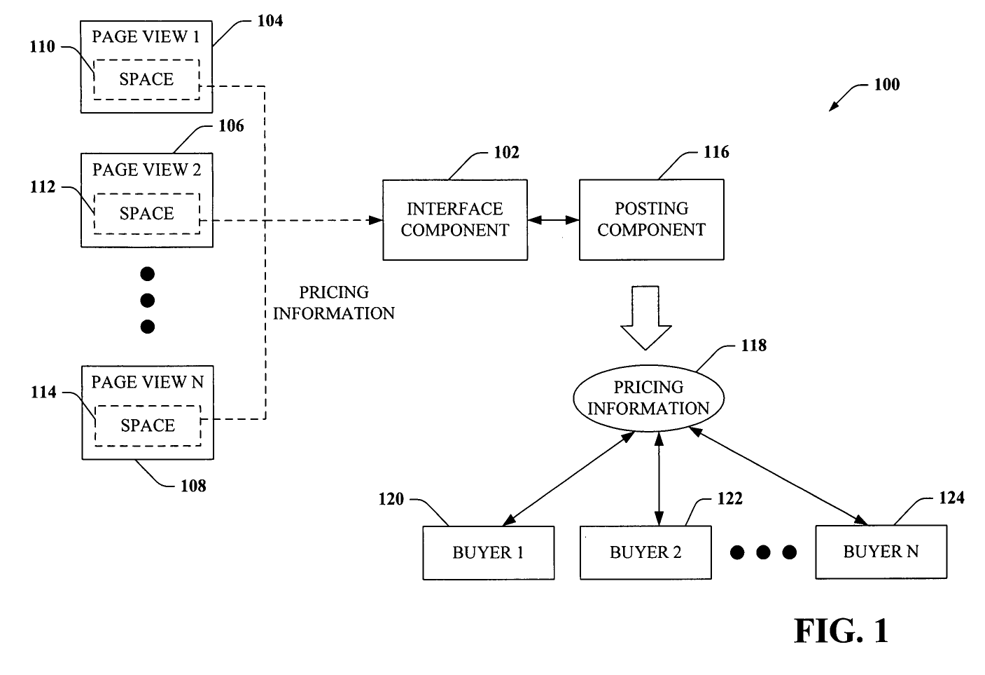

The subject invention will now be described with respect to the drawings, where like numerals represent like elements throughout. The subject invention generally relates to novel systems, methods, articles of manufacture, and/or apparatuses that facilitate sale of space on page views that is utilized for advertising purposes on a posted-price market. A page view is a particular page viewed by a particular user—thus each loaded page can be considered a page view. Referring now to FIG. 1, a system 100 that facilitates sale of advertising spaces associated with page views by way of a posted-price market is illustrated. As described above, conventional systems/methods for selling advertising spaces utilize an auction to sell such spaces, wherein bids are received and analyzed at a time that a web page is loaded. While in some instances sale by auction is desirable, posted-price markets are associated with various benefits over auctions. For instance, market mechanisms often are associated with higher customer satisfaction when compared to auctions, as markets provide buyers with a greater amount of control over purchases when compared to auctions. For instance, buyers can simply review available inventory and prices associated therewith and specify a number of items to purchase, being certain that they can obtain the desired number of items at the specified price. Further, utilization of a market mechanism provides an opportunity to create a futures market, an options market, a derivatives market, and the like, thereby decreasing variance of revenue of a seller and expenditures of a buyer (e.g., leading to more stable revenue and expenditure streams).

The system 100 includes an interface component 102 that receives pricing information relating to a plurality of page views 104-108. In more detail, each of the page views 104-108 is associated with at least one space that can be purchased for advertising purposes. For example, the first page view 104 is associated with at least one space 110, a second page view is associated with at least one space 112, and an Nth page view 108 is associated with at least one space 114. Further, the page views 104-108 can relate to a page returned from a search engine based upon one or more particular search terms, a web page returned from entering a Uniform Resource Locator into a web browser, selection of a link, and the like. The spaces 110-114 that can be purchased can be associated with a location upon the page views 104-108, a size, a timeframe that an advertisement can be displayed upon the page views 104-108, etc. Thus, a space can be defined by way of any number of suitable parameters. To further clarify, the page view 104 may be associated with a search term that is frequently utilized, and the space 110 associated therewith can be of substantial size and in a location that would be desirable to an advertiser. Thus, there may be a high demand (and thus a high price) associated with the space 110. As discussed in more detail below, demand can be estimated and utilized to aid in determining a price for which to sell the space 110.

In accordance with another aspect of the subject invention, the pricing information received by the interface component 102 can relate to a percentage of times that a space will feature a buyer's advertisement. For example, the page view 106 can be associated with a particular search term; therefore, for each instance that the term is entered into a search engine, the page view 106 can be provided to a user. Thus, if the term is entered ten times, then the page view 106 can be generated ten times (and the space 112 can be utilized for advertising ten times). The pricing information provided to the interface component 102 can relate to a percentage of the page views in which an advertisement associated with a buyer will appear. Accordingly, the pricing information can be for ten percent of page views associated with a search term. Therefore, one out of ten times the search term is employed by a search engine, the space 112 will be occupied by an advertisement of a buyer. The percentages can vary per search term and/or content page and can be defined based at least in part upon demand, as it would be beneficial to a buyer to allocate percentages to maximize revenue.

The interface component 102 is communicatively coupled to a posting component 116 that posts pricing information 118 so that it is accessible to a plurality of buyers 120-124. Each of the buyers 120-124 can thus have knowledge of a price associated with each space 110-114 on each page view 104-108, and can purchase a percentage of impressions that will appear in such space 110-114 (where an impression is an advertisement's appearance on a page view). As the posted price market can operate in a manner similar to financial markets, it can be discerned that the purchased percentages of impressions can be bought and sold based upon futures contracts on a futures market. Similarly, the percentages of impressions can be bought and sold based upon options contracts, derivatives contracts, and the like.

To more fully explain various aspects of the subject invention, a specific example is provided herein. It is understood, however, that the example is intended to be explanatory and not limitative in any manner. The first buyer 120 may be a flower company interested in advertising to users of a search engine who are utilizing the term “rose” as a search term. The first page view 104 is associated with searches utilizing such search term, and includes a space 110 that can be purchased for advertising purposes. Pricing information 118 can be posted which indicates a price for a percentage of impressions that the first buyer 120 can purchase. In a particular example, the pricing information 118 can state that the first buyer 120 can purchase the space 110 for ten percent of occurrences of the first page view 104 at a defined price. The first buyer 120 has access to the pricing information 118, as it is posted by the posting component 116. The first buyer 120 can thereafter make a determination regarding whether they wish to undertake such purchase. With further specificity regarding the pricing information 118, such pricing information 118 can define a timeframe that the spaces 110-114 are available, a time in the future that the spaces 110-114 are available, etc. For example, the pricing information 118 can inform the first buyer 120 that a space is available at a particular point in time in the future. Similarly, the pricing information 118 can include option information. Thus, the pricing information 118 can include data that aids the buyers 120-124 in making informed decisions regarding purchases of advertising space.

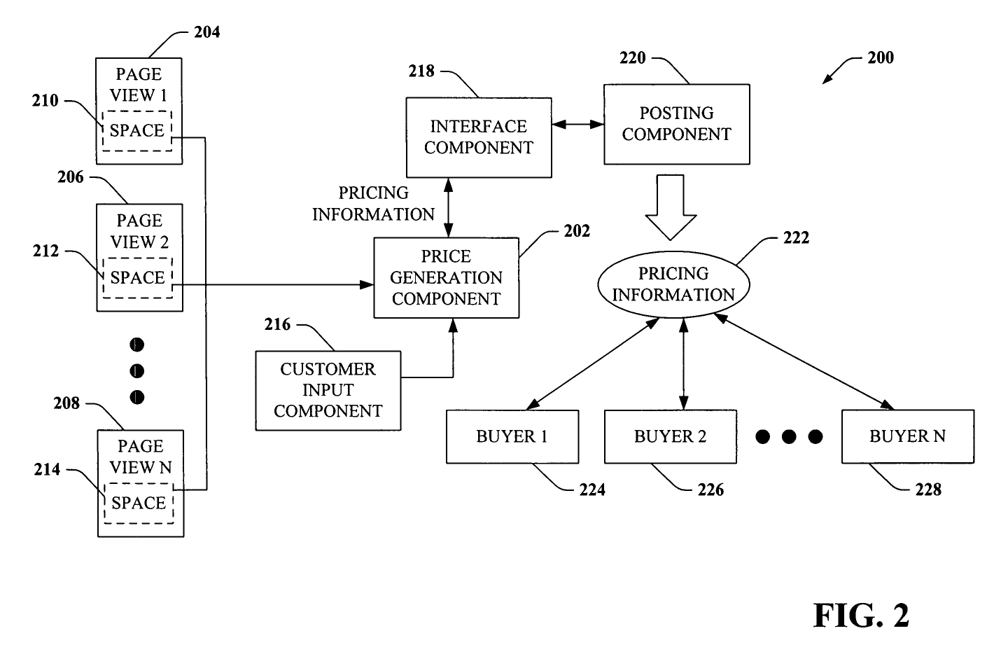

Turning now to FIG. 2, a system 200 that facilitates sale of advertising space with respect to a plurality of page views by way of a posted price market is illustrated. The system 200 includes a price generation component 202 that generates pricing information with respect to a plurality of spaces resident upon a plurality of page views. The spaces can be associated with a particular position on a page view, a specified size, a particular time and/or timeframe, etc. For convenience of terminology, spaces upon a page view can be referred to as partial page views. The price generation component 202 specifically can generate pricing information with respect to page views 204-208 and spaces 210-214 (or partial page views) associated therewith. In accordance with one aspect of the subject invention, the price generation component 202 can analyze supply of the spaces 210-214 associated with the page views 204-208 in connection with determining prices associated with such spaces 210-214. For instance, as the spaces 210-214 can be sold in a market forum, such spaces 210-214 (or percentages associated with traffic relating to the page views 204-208) can be sold as future commodities. The sale of the spaces 210-214 or percentages associated therewith can be tracked to effectively determine supply, and the price generation component 202 can generate pricing information based at least in part upon the supply.

The price generation component 202 can also be associated with a customer input component 216 that enables customers to provide input relating to demand of purchasers or prospective purchasers of the spaces 210-214. For example, a prospective purchaser can indicate that they would be interested in purchasing the space 210 associated with the first page view 204 (which can correspond to a search term entered into a search engine). Data can be voluntarily provided by purchasers or prospective purchases to the customer input component 216 relating to demand associated with one or more spaces—accordingly, data obtained therefrom can be considered in light of possibility of fraud to affect demand (and thus price) in a manner beneficial to a purchaser or prospective purchaser of one or more spaces.

The pricing information generated by the price generation component 202 can be provided to an interface component 218 that is communicatively coupled to a posting component 220. The posting component 220 can post pricing information 222 associated with the page views 204-208 generally and the spaces 210-214 associated therewith specifically to a plurality of prospective buyers 224-228. As described above, the pricing information 222 can relate to a percentage that the buyers 224-228 can purchase, wherein the percentage is associated with a percentage of times that an advertisement will be displayed upon a given page view. Thus, one of the buyers 224-228 can purchase the space 212 for twenty percent of occurrences of the page view 206. For example, if the page view 206 relates to a content page, each time the page is loaded within a specified time range the space 212 will display advertising content relating to one of the buyers 224-228. If the buyer 224 purchases the space 212 for twenty percent of occurrences of the page view 206, then an advertisement associated with the buyer 224 will be displayed in the space 212 twenty percent of the time that the page view 206 is loaded. As the spaces 210-214 (in terms of percentages, for example) can be sold on a posted-price market, creation of a futures market, an options market, a derivatives market, and other suitable markets can be created.

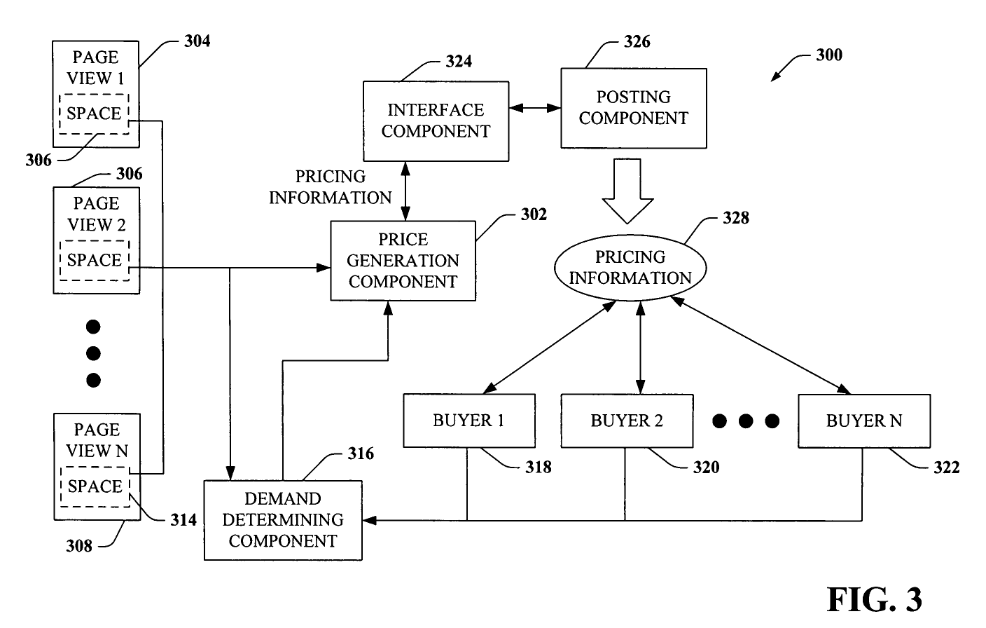

Now referring to FIG. 3, a system 300 that facilitates sale of advertising space upon page views is illustrated. The system 300 includes a price generation component 302 that is employed to generate prices with respect to search pages and/or content pages. For instance, advertisers may wish to advertise on particular web pages and/or with respect to specific search terms (wherein utilization of the terms in a search engine results in search pages). The price generation component 302 can be utilized to generate pricing information with respect to portions of such search pages and/or content pages, thereby enabling prospective buyers to purchase the portions. In more detail, page views 304-308 are generated each time a search is undertaken utilizing a particular search term or terms and/or each time a URL is entered into a web browser (e.g., through typing, traversal of links, . . . ). Advertisers often wish to advertise on spaces 310-314 associated with the page views, particularly in instances that a web page that includes a space is associated with a product sold by a company wishing to advertise on such space. For instance, sporting goods retailers often wish to advertise on web pages relating to sports news as well as search pages where particular terms, such as “golf clubs”, are entered.

A demand determining component can be communicatively coupled to the price generation component 302 and aid in determining a price for each of the spaces 310-314 at particular times. For example, it may be more desirable to advertise near lunch hour when compared to early morning, and the demand determining component 316 can be utilized to determine/estimate such demand at the disparate times. For instance, the demand determining component 316 can monitor the page views 304-308 over several time intervals and track unsold spaces associated therewith, thus indicating a lower demand for such spaces. Further, the demand determining component 316 can monitor purchasing habits of a plurality of buyers 318-322 to aid in determining demand of each of the spaces 310-314 at specified time intervals. In one example, a data repository (not shown) can be utilized to store and organize inventory and purchasing data, and the demand determining component 316 can analyze such data to assist in a determination of demand. It is thus understood that the demand determining component 316 can employ any suitable mechanisms/methodologies for determining and/or estimating demand associated with the page views 304-308 and spaces 310-314 associated therewith.

Upon the pricing generation component 302 creating pricing information associated with the page views 304-308 and related spaces 310-314, such pricing information can be relayed to an interface component 324 that can then relay such pricing information to a posting component 326. The posting component 326 can posting pricing information 328 in a posted-price market to the buyers 318-322, thereby enabling purchase of the spaces 310-314, percentages associated with the spaces 310-314, a particular number of clicks undertaken on the spaces 310-314, a particular number of secure clicks undertaken on the spaces 310-314, or any other suitable manner of selling advertising space upon a web page.

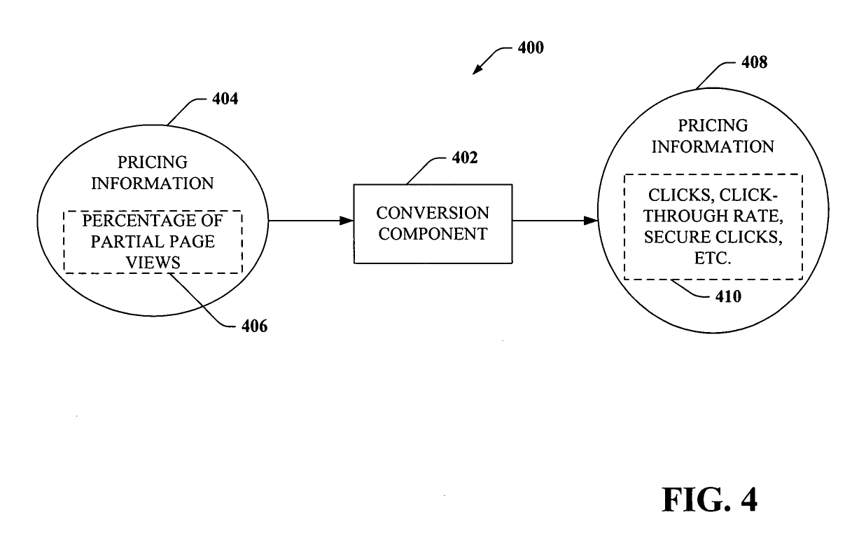

Now referring to FIG. 4, a system 400 that facilitates conversion of a sale of advertising space associated with one parameter to payment for the sale by way of a different parameter. The system 400 includes a conversion component 402 that receives pricing information 404 associated with a partial page view. As described above, a partial page view is a portion of a page view at a particular location, with defined size, and displayed during a specified time interval. In more detail, the pricing information 404 reflects a price for a percentage of partial page views 406. For instance, the pricing information 404 can include a price to be paid by an advertiser for having an advertisement associated therewith displayed on ten percent of page views relating to a content page and/or a search page resultant from specified terms. In some instances, it may be desirable to not convert such pricing information 404 to information based upon other parameters, such as clicks, as click fraud is becoming problematic and it is becoming increasingly difficult to receive payment based thereon. Pricing by way of the percentage of partial page views 406 mitigates occurrences of click fraud so long as advertisements are displayed at random.

Some advertisers, however, may be wary of purchasing advertising space based upon percentages, as there is no guarantee that anyone will actually visit a web page or utilize particular search terms. More specifically, an advertiser may be concerned that they will pay for a percentage of a search term and that such term is not utilized—thus, they have effectively purchased a percentage of zero. Accordingly, to alleviate such concerns, the conversion component 402 can convert the percentage into clicks, click-through rate, secure clicks, acquisitions undertaken by buyers, etc. For example, a purchaser can purchase advertising space by way of percentages, and thereafter have payments based upon clicks, a click-through rate, and the like. The conversion can be specific to an individual or company wishing to utilize space upon a content page or search page to advertise. For instance, a web page can relate to flowers, and a company selling flowers may wish to advertise thereon. The company can purchase space in terms of percentages of page views that will showcase the advertisement, and thereafter request that payment be based upon clicks. Depending at least in part upon an expected number of clicks that the advertisement will receive, a price per click can be generated by the conversion component 402, and such price per click will be associated with a particular value. If the advertiser is selling sporting goods, however, the price per click will most probably be higher, as fewer clicks can be expected to occur for sporting goods upon a web page relating to flowers. In other words, the conversion component 402 can convert pricing information from a first format to a disparate format in a manner that does not negatively impact a seller's expected revenue.

While not shown, it is understood that conversion tables can be associated with particular spaces as well as specific purchasers to effectuate conversion of the pricing information. Moreover, the conversion component 402 can convert from percentage-based pricing information to a combination of disparate pricing parameters. For instance, converted pricing information 408 can be a combination of clicks, click-through rate, secure clicks, acquisitions, etc. (e.g., the advertiser may wish to pay a first amount per click, a second amount per secure click, . . . ). The conversion component 402 facilitates converting pricing information to be based upon any suitable parameter so that converted pricing information 408 is based at least in part upon such parameters 410.

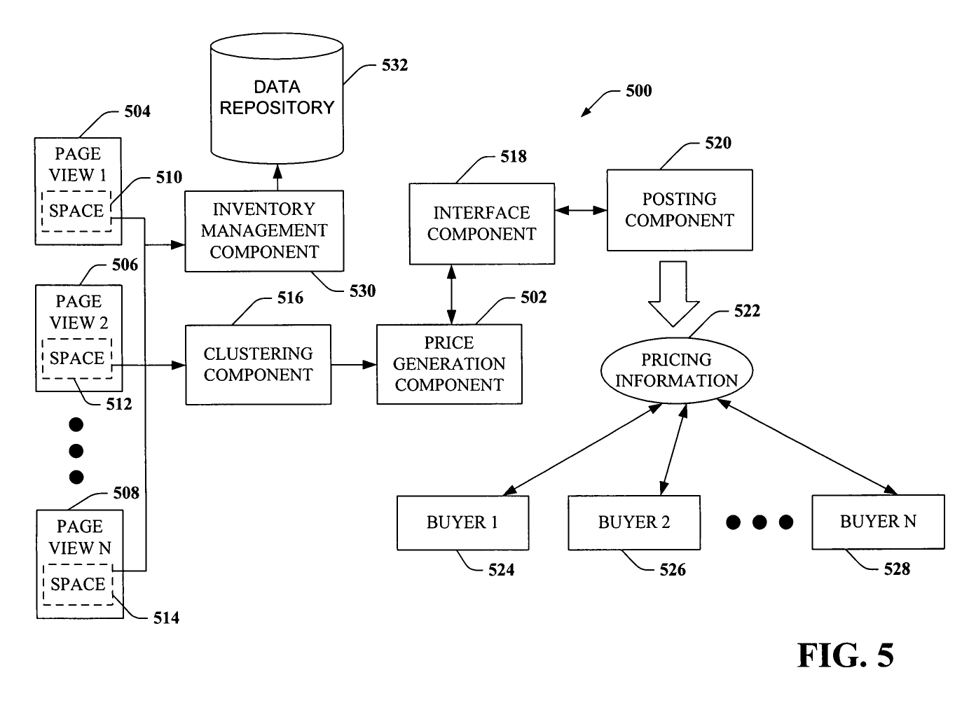

Turning now to FIG. 5, a system 500 that facilitates sale of partial page views (e.g., advertising spaces) by way of a posted-price market is illustrated. The system 500 includes a price generation component 502 that is utilized to generate pricing information with respect to a plurality of page views 504-508 and a plurality of spaces 510-514 therein. As described above, the pricing information created by the price generation component 502 can be based at least in part upon a percentage of page views in which a purchased space will display an advertisement associated with a purchaser. Furthermore, while each of the page views 504-508 is shown as including one space, it is understood that the page views 504-508 can each include a plurality of spaces.

The price generation component 502 can be coupled to a clustering component that can cluster spaces together for pricing purposes. For example, spaces can be clustered based at least in part upon expected demand, location, information on a web page, or any other suitable manner. Further, it may be beneficial to cluster low-demand spaces so that prices of such spaces are not driven to zero. Upon receiving the clusters, the price generation component 502 can provide pricing information to an interface component 518, which is coupled to a posting component 520. The posting component 520 can post pricing information 522 in a posted-price market so that it is available to a plurality of prospective buyers 524-528. One or more of the buyers 524-528 can then specify a quantity (e.g., in terms of percentages) that they desire to purchase.

As with any market, it is important to ensure that the seller is not overselling. In other words, the posting component 520 should only post prices with respect to spaces that have not been sold out. An inventory management component 530 can track sales of the spaces 510-514 and organize inventory within a data repository 532. While not shown as such, the price generation component 502 and the clustering component 516 can access the data repository 532 to aid in determining which spaces to cluster (e.g., clustering can be accomplished as a function of availability of the spaces 510-514), aid in determining demand, and aid in posting the pricing information 522. Furthermore, the data repository 532 can hold historical data relating to prior purchases, thereby enabling analysis of data therein to more accurately determine demand and thus drive the pricing information 522 to a market equilibrium and/or revenue maximizing point.

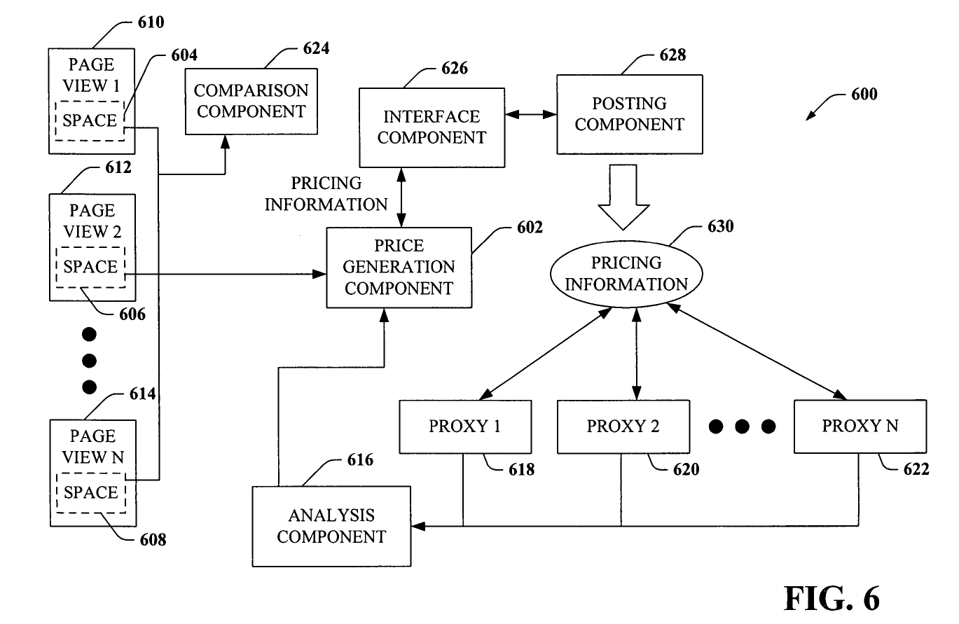

Now turning FIG. 6, a system 600 that facilitates determining pricing information associated with a plurality of advertising spaces on a plurality of page views and selling such spaces in a posted-price market is illustrated. The system 600 includes a price generation component 602 that is employed to determine pricing information with respect to a plurality of spaces 604-608 associated with a plurality of page views 610-614. For instance, the price generation component 602 can determine pricing information that relates to a percentage of page views in which a purchased advertisement will appear. The system 600 further includes an analysis component 616 that can analyze a plurality of proxies 618-622 that are associated with programmed demand curves of buyers represented by such proxies 618-622. In accordance with one aspect of the subject invention, the demand curves can be published, thereby enabling the analysis component 616 to quickly determine a demand associated with particular spaces. In most instances, however, it is desirable for purchasers and sellers to not publish the demand curves associated with the proxies 618-622, as then such demand curves could be subject to fraud. Therefore, the analysis component 616 can track activity of the proxies 618-622 to estimate demand of purchasers utilizing the proxies 618-622.

The system can further include a comparison component 624 that is employed to compare spaces and/or sets of spaces that may be characterized as similar and adjust prices of at least one of the sets of spaces based at least in part upon the comparison. For instance, two similar spaces (e.g., spaces with similar positions, sizes, and on similar web sites) should not be associated with widely dissimilar prices. The comparison component 624 can compare spaces and/or sets of spaces to further refine pricing information associated with the spaces 604-608. Upon price associated with the spaces 604-608 being determined, the price generation component 602 can communicate with an interface component 626, which can in turn communicate with a posting component 628. The posting component 628 can post pricing information 630 in a posted-price market in a manner that purchases of the spaces 604-608 (or percentages associated therewith) can be effectuated by the proxies 618-622.

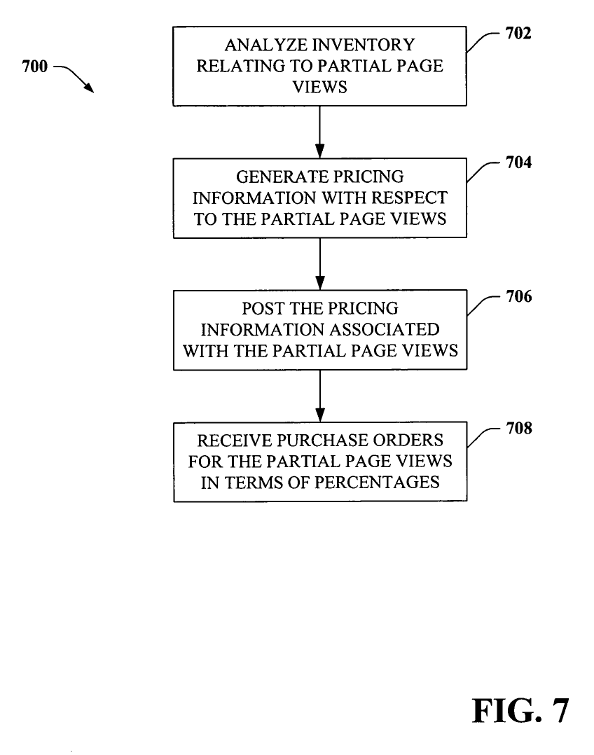

Referring now to FIGS. 7-12, methodologies in accordance with the subject invention will now be described by way of a series of acts. It is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning solely to FIG. 7, a methodology 700 for creating a posted-price market with respect to partial page views is illustrated. At 702, inventory relating to partial page views is analyzed. For instance, a data repository can be employed to store and organize inventory information, such as partial page views that are currently available for purchase, partial page views that are available for purchase at specific times in the future, options associated with partial page views, and any other data that may be relevant to inventory. Analyzing inventory is important as availability directly affects demand, which in turn affects price. Further, it is important not to sell more advertising space than what is available, as some countries associated treble damages when items are sold beyond availability. It is also important not to undersell the partial page views, as underselling can adversely affect revenue of the salesperson. Accordingly, a robust inventory system and analysis thereof can aid in effectuation of a posted-price market with respect to advertising space.

At 704, pricing information is generated with respect to the partial page views. For example, the analysis of inventory can be utilized to assist in determining available supply of partial page views as well as demand for available partial page views. Pricing information can thereafter be generated based at least in part upon the supply and demand. Furthermore, the pricing information can be generated in a manner so that a purchaser isn't purchasing a certain number of impressions. Rather, the purchaser can be purchasing a percentage of page views in which an advertisement associated with the purchaser will appear. For example, the purchaser can purchase a percentage of partial page views associated with a search term or terms. Similarly, the purchaser can purchase a percentage of partial page views relating to a content page. In accordance with another aspect of the subject invention, the percentages associated with search terms can alter depending upon a location of the search term within a search. For example, the purchaser can receive a first percentage when a term is a sole term utilized in a search, a second percentage with a term is amongst a plurality of terms, a third percentage if the term is located at a beginning of a series of search terms, a fourth percentage if the term is located at an end of a series of search terms, etc. Thus, as can be discerned from this example, the pricing information can alter given disparate parameters associated with a search term.

At 706, the pricing information generated at 704 is posted in a manner so that a plurality of prospective buyers can review such information to determine whether to purchase one or more partial page views. For example, it can be posted so that proxies associated with the prospective buyers can utilize programmed demand curves to determine whether to purchase partial page views. The posting can be completed at any suitable location. At 708, purchase orders are received for the partial page views in terms of the aforementioned percentages. The consummated sale can relate to a time in the future that the advertisements will be displayed, can include options associated with displaying advertisements, and the like. Thus, a futures market, an options market, a derivatives market, and the like is enabled through utilization of the methodology 700.

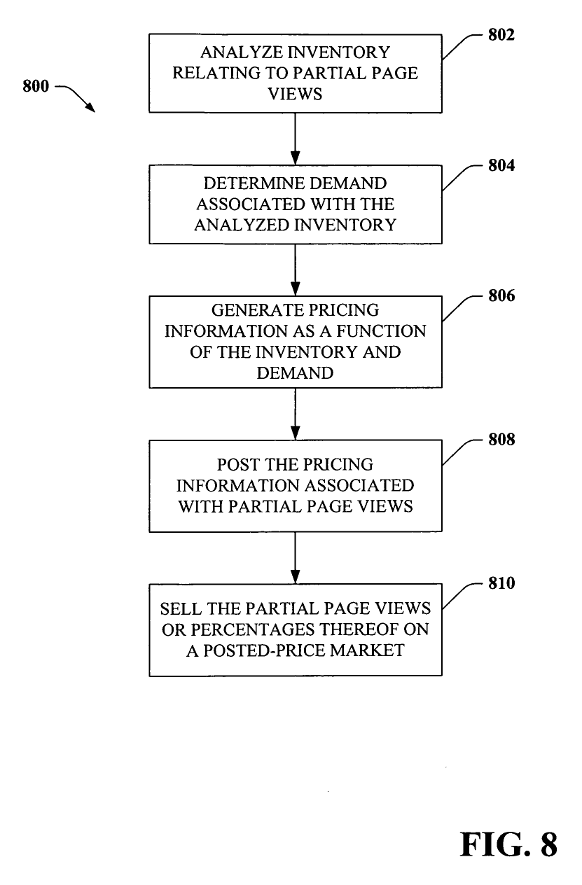

Now referring to FIG. 8, a methodology 800 for implementing a posted-price market with respect to on-line advertisements is illustrated. At 802, inventory is analyzed relating to partial page views. At 804, demand associated with the analyzed inventory is determined. For example, a data repository that includes historical data relating to purchase of partial page views can be analyzed to estimate demand associated with such partial page views. Furthermore, demand curves of proxies may be made available, and thus demand can be determined by analyzing such demand curve. Any suitable determination/estimation of demand, however, is contemplated by the inventors of the subject invention and intended to fall under the scope of the hereto-appended claims.

At 806, pricing information is generated as a function of the available inventory and the demand. Thus, a classical supply/demand analysis can be utilized in determining pricing information. The prices can be determined according to a strategy of a seller. For instance, if maximum revenue is desired, then supply can be artificially altered in order to maximize revenue. In a disparate strategy, market equilibrium may be desired—accordingly, supply may not be artificially altered (thus artificially affecting demand). At 808, the pricing information associated with the partial page views is posted, and at 810 the partial page views are offered for sale on a posted-price market. As described above, the market can be an options market, a futures market, a derivatives market, and the like.

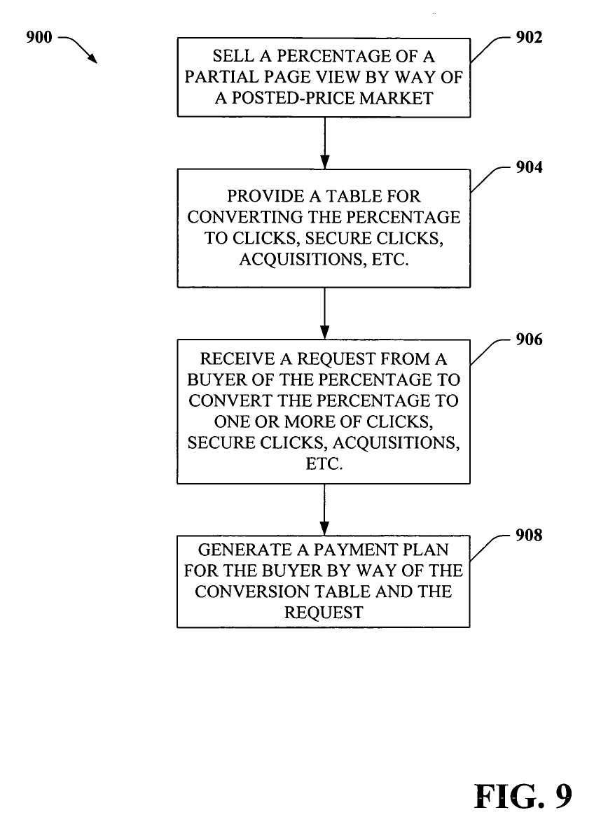

Turning now to FIG. 9, a methodology 900 for converting pricing information with respect to a percentage of page views that will display an advertisement to a payment method preferred by a buyer. At 902, a percentage of a partial page view is sold by way of a posted-price market. As described above, the percentage of the partial page view refers to a percentage of page views that will include an advertisement associated with a buyer. At the time of purchase, however, payment may not be finalized. Rather, the purchaser can opt for a payment plan based upon clicks, click through rate, secure clicks, acquisitions, and the like.

At 904, a table is provided that enables conversion of the percentage into one or more of clicks, secure clicks, acquisitions, or any other suitable parameter. For instance, a price with respect to the percentage of the partial page view can be determined. It is desirable for the purchaser to provide payment for as near to the determined price as possible. Thus, for example, if the purchaser desires to pay based upon clicks, then an expected number of clicks can be calculated given the purchased percentage of the partial page view. Such information can be included within the conversion table, as well as conversions to various other payment options. Furthermore, as the purchased percentage of the partial page views can be subject to resale, conversion may not take place until implementation of the advertisement, as conversion factors will differ for disparate purchasers. At 906, a request from a buyer to convert the percentage of the partial page views to payment based at least in part upon clicks, secure clicks, click through rate, and/or acquisitions is received, and at 908 a payment plan is generated by way of the conversion table and the request. Accordingly, the seller will receive approximately the same revenue as if the conversion had not taken place, and the buyer will be able to select a payment plan of their choice.

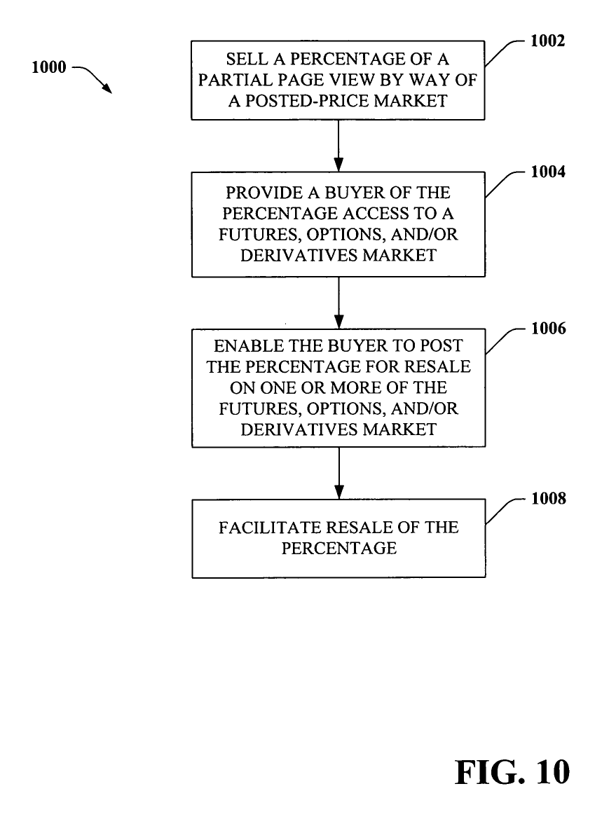

Now referring to FIG. 10, a methodology for selling and re-selling on-line advertising space is illustrated. At 1002, a percentage of a partial page view is sold by way of a posted-price market. At 1004, a buyer of such percentage is provided with access to a futures, options, and /or derivatives market. At 1006, the buyer is enabled to post the percentage for resale on one or more of the futures, options, and/or derivatives market, depending upon a type of item originally purchased. At 1008, resale of the percentage is facilitated within such market. Thus, utilizing one or more aspects of the subject invention, advertisers can view buying and selling of advertising space as both an investment in advertising as well as a conventional financial investment. Thus, if a prospective purchaser speculates that certain search terms will be employed with greater frequency at a future point in time, such prospective purchaser can purchase advertising space by way of a futures contract.

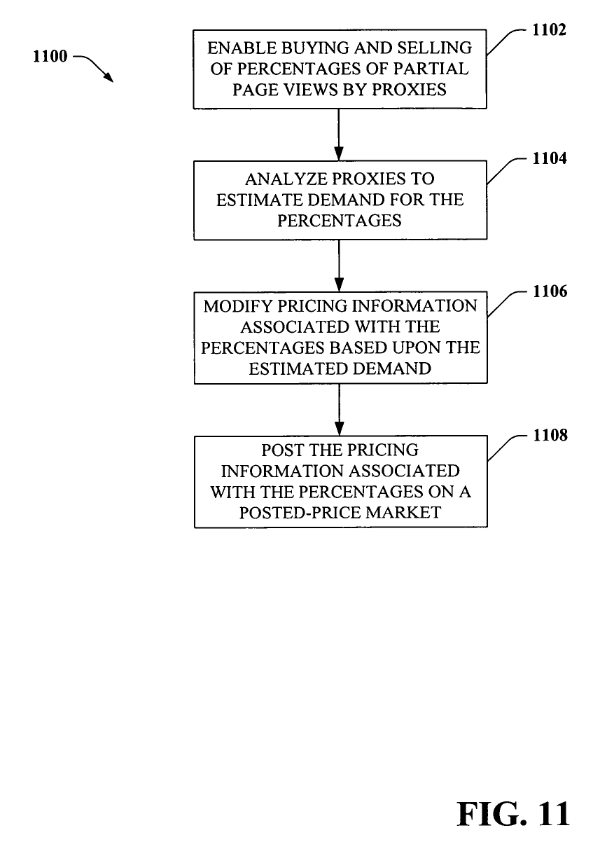

Turning now to FIG. 11, a methodology 1100 for determining pricing information associated with on-line advertising space is illustrated. At 1102, buying and selling of percentages of partial page views by proxies is illustrated. For example, proxies structured in a manner that enables use of a demand curve to purchase advertising space and that further include authority to buy and sell advertising space can be employed in accordance with the subject invention. The demand curve can be published or encrypted within a proxy module. At 1104, the proxies are analyzed to estimate demand for the percentages of the partial page views. For instance, if the demand curve associated with the proxies is published, then demand for particular search terms can quickly be determined. If, however, the demand curves are encrypted, then analysis over time may be necessary to obtain an accurate estimate of demand. At 1106, pricing information of the percentages of the partial page views is modified based upon the estimated demand, and at 1108 the pricing information is posted on a posted-price market.

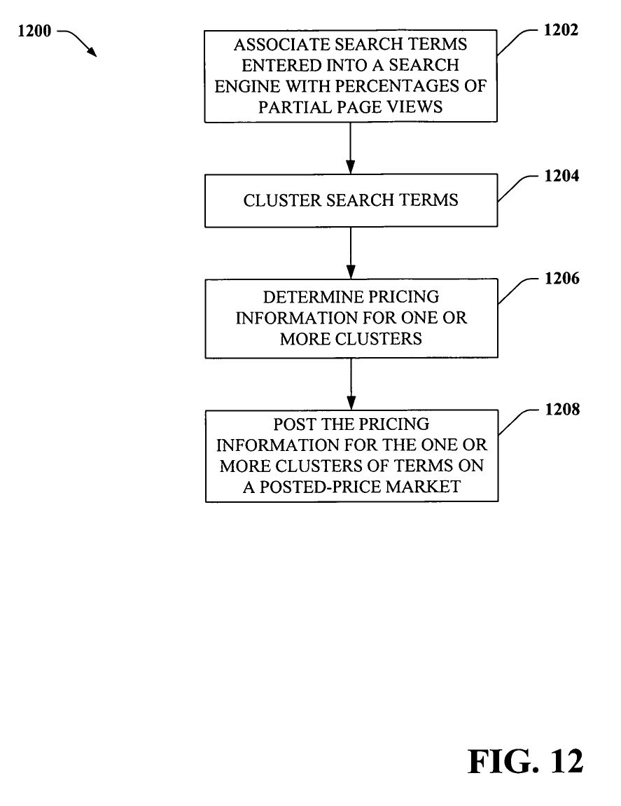

Turning now to FIG. 12, a methodology 1200 for pricing percentages of partial page views is illustrated. At 1202, search terms that can be entered into a search engine are associated with partial page views in general, and more specifically associated with percentages of the partial page views in which advertisement space can be purchased. For instance, it may be desirable to sell a first search term in percentage packages of ten percent, while it may be desirable to sell a second search term in percentage packages of five percent. At 1204, search terms are clustered in accordance with any suitable parameter. For instance, terms can be clustered according to demand, according to type, or any other suitable parameter. At 1206, pricing information is determined for one or more of the clusters, and at 1208 the pricing information for the one or more clusters is posted on a posted-price market. Such clustering and pricing of clusters (rather than individual search terms) can enhance efficiency of a market.

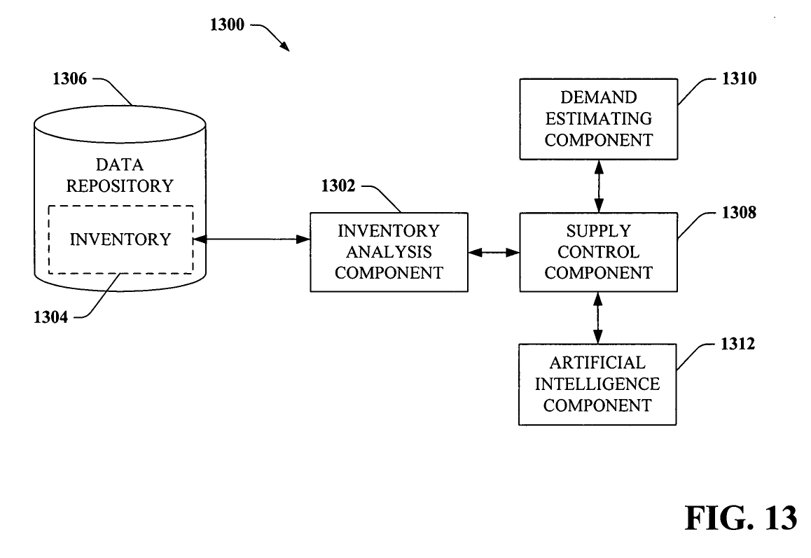

Now referring to FIG. 13, a system 1300 that facilitates artificially controlling supply (and thus controlling demand) with respect to on-line advertising space is illustrated. The system 1300 includes an inventory analysis component 1302 that analyzes inventory 1304 or records of inventory within a data repository 1306. For instance, the inventory analysis component 1302 can determine particular trending information associated with purchases of on-line advertising space, review remaining spaces and calculate probabilities associated with sale of such spaces at current prices, probabilities of sale associated with disparate price ranges, and other suitable analysis. The system 1300 can further include a supply control component 1308 that can alter supply to comport with a market strategy. For instance, to maximize revenue, instances will exist that it is more profitable long term not to sell certain spaces than it is to sell the spaces at low cost. Thus, the supply control component 1308 can limit supply to maximize revenue if desired. The supply component 1308 can later provide supply if a greater demand for particular spaces is estimated/determined.

Demand can be estimated by a demand estimating component 1310. While not shown as such, the demand estimating component 1310 can be directly coupled to the data repository 1306, which can include data relating to past sales of on-line advertising space. The historic data can be analyzed to estimate a current demand. The supply control component 1308 can further be associated with an artificial intelligence component 1312 that can generate inferences relating to altering supply of on-line advertising space provided for sale on a posted-price market. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject invention.

For a particular example, the artificial intelligence component 1312 can monitor fluctuations in supply and fluctuations in revenue over time, and make inferences to correct market anomalies that may exist with respect to such fluctuations. For example, the artificial intelligence component 1312 can determine that particular search terms are utilized with high frequency seasonally, and are employed with low frequency outside of such frequency. Accordingly, demand for advertisements associated with search pages that result from utilization of the term in a search engine are low when frequency of utilization of the term is low. To maximize revenue and maintain sufficient demand for advertisements associated with the term, supply of advertising spaces associated with the term can be limited except for when such term is utilized with high frequency.

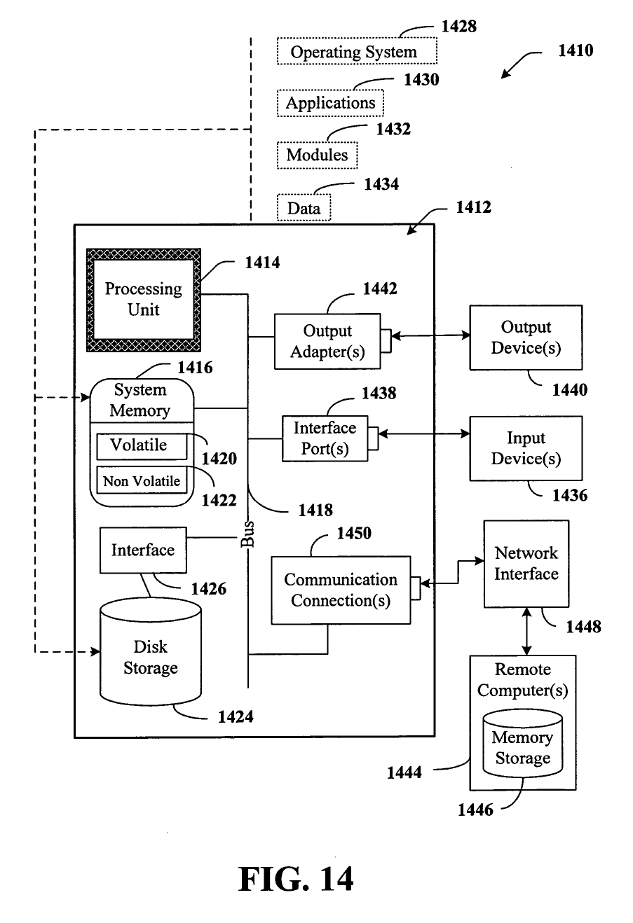

In order to provide additional context for various aspects of the subject invention, FIG. 14 and the following discussion are intended to provide a brief, general description of a suitable operating environment 1410 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1410 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 14, an exemplary environment 1410 for implementing various aspects of the invention includes a computer 1412. The computer 1412 includes a processing unit 1414, a system memory 1416, and a system bus 1418. The system bus 1418 couples system components including, but not limited to, the system memory 1416 to the processing unit 1414. The processing unit 1414 can be any of various available processors. Dual microprocessors and other multiprocessor architectures also can be employed as the processing unit 1414.

The system bus 1418 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI). The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable ROM (EEPROM), or flash memory. Volatile memory 1420 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1412 also includes removable/nonremovable, volatile/nonvolatile computer storage media. FIG. 14 illustrates, for example a disk storage 1424. Disk storage 1424 includes, but is not limited to, devices like a magnetic disk drive, floppy disk drive, tape drive, Jaz drive, Zip drive, LS-100 drive, flash memory card, or memory stick. In addition, disk storage 1424 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1424 to the system bus 1418, a removable or non-removable interface is typically used such as interface 1426.

It is to be appreciated that FIG. 14 describes software that acts as an intermediary between users and the basic computer resources described in suitable operating environment 1410. Such software includes an operating system 1428. Operating system 1428, which can be stored on disk storage 1424, acts to control and allocate resources of the computer system 1412. System applications 1430 take advantage of the management of resources by operating system 1428 through program modules 1432 and program data 1434 stored either in system memory 1416 or on disk storage 1424. It is to be appreciated that the subject invention can be implemented with various operating systems or combinations of operating systems.

A user enters commands or information into the computer 1412 through input device(s) 1436. Input devices 1436 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1414 through the system bus 1418 via interface port(s) 1438. Interface port(s) 1438 include, for example, a serial port, a parallel port, a game port, and a universal serial bus (USB). Output device(s) 1440 use some of the same type of ports as input device(s) 1436. Thus, for example, a USB port may be used to provide input to computer 1412, and to output information from computer 1412 to an output device 1440. Output adapter 1442 is provided to illustrate that there are some output devices 1440 like monitors, speakers, and printers among other output devices 1440 that require special adapters. The output adapters 1442 include, by way of illustration and not limitation, video and sound cards that provide a means of connection between the output device 1440 and the system bus 1418. It should be noted that other devices and/or systems of devices provide both input and output capabilities such as remote computer(s) 1444.

Computer 1412 can operate in a networked environment using logical connections to one or more remote computers, such as remote computer(s) 1444. The remote computer(s) 1444 can be a personal computer, a server, a router, a network PC, a workstation, a microprocessor based appliance, a peer device or other common network node and the like, and typically includes many or all of the elements described relative to computer 1412. For purposes of brevity, only a memory storage device 1446 is illustrated with remote computer(s) 1444. Remote computer(s) 1444 is logically connected to computer 1412 through a network interface 1448 and then physically connected via communication connection 1450. Network interface 1448 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1450 refers to the hardware/software employed to connect the network interface 1448 to the bus 1418. While communication connection 1450 is shown for illustrative clarity inside computer 1412, it can also be external to computer 1412. The hardware/software necessary for connection to the network interface 1448 includes, for exemplary purposes only, internal and external technologies such as, modems including regular telephone grade modems, cable modems and DSL modems, ISDN adapters, and Ethernet cards.

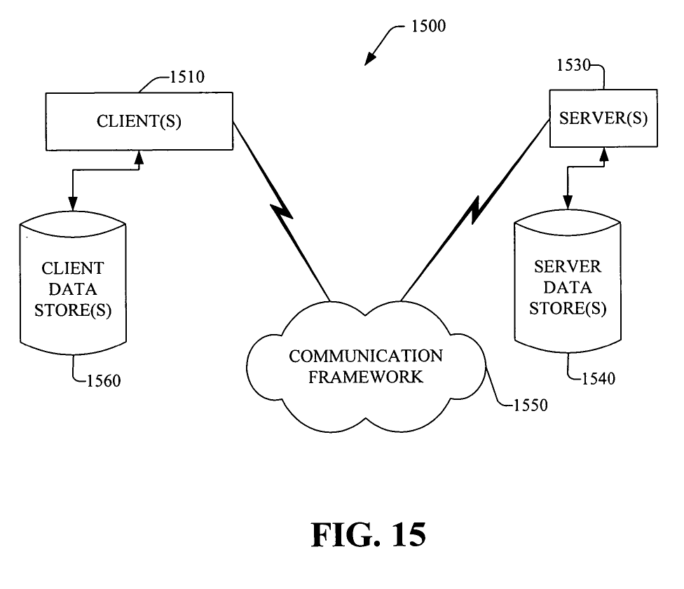

FIG. 15 is a schematic block diagram of a sample-computing environment 1500 with which the subject invention can interact. The system 1500 includes one or more client(s) 1510. The client(s) 1510 can be hardware and/or software (e.g., threads, processes, computing devices). The system 1500 also includes one or more server(s) 1530. The server(s) 1530 can also be hardware and/or software (e.g., threads, processes, computing devices). The servers 1530 can house threads to perform transformations by employing the subject invention, for example. One possible communication between a client 1510 and a server 1530 can be in the form of a data packet adapted to be transmitted between two or more computer processes. The system 1500 includes a communication framework 1550 that can be employed to facilitate communications between the client(s) 1510 and the server(s) 1530. The client(s) 1510 are operably connected to one or more client data store(s) 1560 that can be employed to store information local to the client(s) 1510. Similarly, the server(s) 1530 are operably connected to one or more server data store(s) 1540 that can be employed to store information local to the servers 1530.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates sale of advertising space on a plurality of search pages by way of a posted-price market, comprising:
an interface component that receives pricing information relating to a plurality of spaces on the plurality of search pages; and
a posting component communicatively coupled to the interface component that posts the pricing information so that the pricing information is accessible to a prospective buyer.

2. The system of claim 1, further comprising a price generation component that determines the pricing information.

3. The system of claim 2, the pricing information is based at least in part on one or more of size of a space on a search page, location of a space on a search page, duration that a space will be utilized for advertising, and demand associated with a space on a search page.

4. The system of claim 1, the plurality of spaces are associated with one or more terms that are utilized in connection with a search engine.

5. The system of claim 1, the plurality of spaces are associated with one or more Uniform Resource Locators.

6. The system of claim 1, the plurality of spaces are associated with one or more of time of day, day of week, and user attributes.

7. The system of claim 1, further comprising a customer input component that receives information from customers relating to demand of advertising with respect to one or more of the plurality of spaces.

8. The system of claim 1, further comprising a demand determining component that estimates demand associated with advertising on one or more of the plurality of spaces.

9. The system of claim 1, the pricing information further relates to a percentage of page views that will display advertisements relating to a purchaser on at least one of the plurality of spaces.

10. The system of claim 9, the percentage of page views is associated with a portion of a search term, the portion comprising one of a prefix of the search term and a suffix of the search term.

11. The system of claim 9, further comprising a conversion component that converts price based upon the percentage to price based at least in part upon one or more of clicks, secure clicks, click through rate, and purchases resulting from a sale by way of a selected advertisement.

12. The system of claim 11, further comprising an estimation component that estimates conversion factors based at least in part upon identity of a purchaser of the percentage.

13. The system of claim 1, further comprising an inventory management component that facilitates arrangement and storage of inventory associated with the plurality of spaces.

14. The system of claim 1, further comprising a clustering component that clusters search terms associated with the plurality of spaces, the pricing information based at least in part upon the clustering.

15. A computer-implemented method that facilitates on-line advertising, comprising:
providing a plurality of impressions for sale to prospective buyers; and
selling a subset of the impressions to at least one of the buyers based on percentage of page views that will include the subset of impressions.

16. The method of claim 15, further comprising selling the subset of the impressions as a futures contract.

17. The method of claim 15, further comprising selling the subset of the impressions in connection with an options contract.

18. The method of claim 15, further comprising:
analyzing available supply of the plurality of impressions; and
estimating demand associated with the plurality of impressions.

19. The method of claim 18, further comprising generating pricing information for the subset of the impressions.

20. A system that facilitates sale of advertising space on page views by way of a posted price market, comprising:
means for offering impressions for sale, the sale of impressions based at least in part upon a percentage of page views for which the impressions will relate to a buyer; and
means for converting the sale of impressions so that it is based at least in part upon one or more of clicks, secure clicks, click through rate, and acquisitions.
